(19) United States
(12) Patent Application Publication
(10) Pub. No.: US 2008/0048867 A1
(43) Pub. Date: Feb. 28, 2008

(54) Discontinuous-Loop RFID Reader Antenna And Methods

(76) Inventors: Ronald A. Oliver, Seattle, WA (US); Gregory T. Kavounas, Kirkland, WA (US)

Correspondence Address: Merchant & Gould P.C., P.O. Box 2903, Minneapolis, MN, 55402-0903, US

(21) Appl. No.: 11/623,403

(22) Filed: Jan. 16, 2007

Related U.S. Application Data
(63) Continuation-in-part of application No. 29/265,163, filed on Aug. 25, 2006.
(60) Provisional application No. 60/760,058, filed on Jan. 18, 2006.

(51) Int. Cl. G08B 13/14; H01Q 9/04

(52) U.S. Cl. 340/572.7; 343/700 MS

(57) ABSTRACT

RFID reader antennas and methods for generating magnetic fields. An antenna can be made from conductors that do not contact each other, but have loop portions spatially arranged along a loop section. The loop portions have gaps between them, and thus the loop section is discontinuous. The loop section can be driven from near its ends by a UHF RFID excitation signal, which travels through the loop portions, and also through the gaps because it is AC. Thus an excitation current becomes established along the loop section, which generates a useable magnetic field. Each loop portion can be short, so that the magnetic field it contributes will not self-cancel due to the shorter wavelength of UHF RFID. The loop section can be large independently of the wavelength, so that the magnetic field is of a size large enough to be useful for ILT in RFID.

### RELATED APPLICATIONS

This patent application claims priority from U.S. Provisional Patent Application No. 60/760,058, filed on Jan. 18, 2006, Attorney Docket No. 50133.53USPI/IMPJ-0180P, the disclosure of which is hereby incorporated by inference for all purposes.

This is a Continuation-In-Part patent application from U.S. Design patent application Ser. No. 29/265,163, filed on Aug. 25, 2006, Attorney Docket No. 50133.53US01/IMPJ-0234DS, the disclosure of which is hereby incorporated by reference for all purposes.

### FIELD OF THE INVENTION

The present description addresses the field of Radio Frequency IDentification (RFID) systems, and more specifically to antennas for RFID systems and methods of driving them.

### BACKGROUND

Radio Frequency IDentification (RFID) systems typically include RFID tags and RFID readers (the latter are also known as RFID reader/writers or RFID interrogators). RFID systems can be used in many ways for locating and identifying objects to which the tags are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using an RFID reader to interrogate one or more RFID tags. The reader transmitting a Radio Frequency (RF) wave performs the interrogation. A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected-back RF wave may further encode data stored internally in the tag, such as a number. The response is demodulated and decoded by the reader, which thereby identities, counts, or otherwise interacts with the associated item. The decoded data can denote a serial number, a price, a date, a destination, other attribute(s), any combination of attributes, and so on.

An RFID tag typically includes an antenna system, a power management section, a radio section, and frequently a logical section, a memory, or both. In earlier RFID tags, the power management section included an energy storage device, such as a battery. RFID tags with an energy storage device are known as active tags. Advances in semiconductor technology have miniaturized the electronics so much that an RFID tag can be powered solely by the RF signal it receives. Such RFID tags do not include an energy storage device, and are called passive tags.

A problem occurs when RFID tags are intended to be read in a way that the RF waves go have to go through media like metals and liquids. These media reflect or absorb the electric field component of RF waves, thus hampering communication.

### SUMMARY

The present invention overcomes the problem of the prior art.

In some embodiments, communication takes place using the magnetic field component of RF waves. RFID tags can respond to the magnetic field component in a manner similar to that of the electric field component.

A discontinuous-loop antenna can be made according to embodiments of the invention, which is larger than would be ordinarily permitted by the prior art, given the smaller wavelength dimensions of the otherwise preferred higher RFID frequencies. These embodiments can be further driven according to methods of the invention by an RFID reader. The result is a relatively large magnetic field, which can be used to read the RFID tags.

Using this large field, the system can operate to exchange information with the tags at a higher frequency, namely in the 900 MHz range, or even the 2.4 GHz range, instead of the 13 MHz range of the prior art. This way data can be exchanged much faster, which in turn permits much higher throughputs.

Further advantages occur if the 900 MHz frequency range is chosen. First, it is subject to a single standard for RFID communication over the air interface, which prevents confusion. This is unlike the situation with the 13 MHz frequency range, which is subject to two or more standards, each at slightly different frequencies.

Second, the 900 MHz frequency range is already the technology often used for container level tagging, namely tagging pallets, cartons, crates and the like. Now the same technology can also be used for Item Level Tagging (ILT), namely tagging items at the individual level, such as pharmaceuticals, etc. This way, warehouses and the like can be equipped with a single RFID technology, which is simpler than if different frequencies were used.

In a number of embodiments, the discontinuous-loop antenna can work with the same excitation signal as a prior art dipole type antenna. So, the same RFID reader can be used, and antennas can be interchanged.

In some further embodiments, the discontinuous-loop antenna advantageously further generates a far field pattern that is indistinguishable from that generated by a dipole. As such, the dipole antenna may no longer be needed.

This and other features and advantages of the invention will be better understood in view of the Detailed Description and the Drawings, in which:

### BRIEF DESCRIPTION OF THE DRAWINGS

Non-limiting and non-exhaustive embodiments are described with reference to the following drawings.

FIG. 1 is a block diagram of components of an RFID system.

FIG. 2A is a diagram showing components of a first passive RFID tag, such as a tag that can be used in the system of FIG. 1.

FIG. 2B is a diagram showing components of a second passive RFID tag, such as a tag that can be used in the system of FIG. 1, and which is further adapted for being made in relatively smaller dimensions and respond to a magnetic field.

FIG. 3 is a conceptual diagram for explaining a half-duplex mode of communication between the components of the RFID system of FIG. 1.

FIG. 4 is a block diagram showing a detail of an RFID reader system, such as the one shown in FIG. 1.

PIG. 5 is a diagram of a prior art dipole RFID reader antenna.

FIG. 6 is a diagram of a prior art solid loop RFID reader antenna.

FIG. 7A is a block diagram of components of a discontinuous-loop antenna according to an embodiment of the invention, in which there is a single loop section made from three conductors, separated by gaps, in a single row.

FIG. 7B is a diagram showing the single loop section of FIG. 7A, and the induced excitation current.

FIG. 8 is a composite diagram of a flowchart for describing methods, and of an aggregate for showing how individual magnetic field components can be added, according to embodiments of the invention.

FIG. 9A is a block diagram of components of a discontinuous-loop antenna according to an embodiment of the invention, in which there are two loop sections, each made from two conductors in a single row.

FIG. 9B is a diagram showing the two loop sections of FIG. 9A, and their induced excitation currents.

FIG. 10A is a perspective diagram showing how a discontinuous-loop antenna according to embodiments produces a substantially uniform magnetic field.

FIG. 10B is a perspective diagram showing how the antenna of FIG. 10A can be oriented with respect to a conveyor belt according to embodiments.

FIG. 10C is a diagram showing a substantially elliptically shaped single loop section that can be formed by proper orientation of conductors in a discontinuous-loop antenna according to embodiments.

FIG. 10D is a diagram showing a substantially rectangularly shaped single loop section that can be formed by proper orientation of conductors in a discontinuous-loop antenna according to embodiments.

FIG. 11 is a diagram of conductors for a discontinuous-loop antenna made according to an embodiment where there are 5 conductors in a single row.

FIG. 12 is a diagram of conductors for a discontinuous-loop antenna made according to an embodiment where there are many conductors in a single row.

FIG. 13 is a diagram of conductors for a discontinuous-loop antenna made according to art embodiment where the conductors leave an inefficiently large gap.

FIG. 14 is a diagram of conductors for a discontinuous-loop antenna made according to an embodiment where the conductors have slanted ends.

FIG. 15 is a diagram of conductors for a discontinuous-loop antenna made according to an embodiment where the conductors are arranged in two rows.

FIG. 16 is a diagram of conductors for a discontinuous-loop antenna further showing exact dimensions that are known to work well.

FIG. 17 is a diagram of conductors for a discontinuous-loop antenna made according to an embodiment where there are conductors arranged in three rows.

FIG. 18 is a diagram showing a computation discontinuous-loop and dipole antenna according to embodiments.

FIG. 19 is a diagram of loop section of a discontinuous-loop antenna according to embodiments, for discussing versatility of designs.

FIG. 20 is a diagram of a discontinuous-loop antenna according to other embodiments.

FIG. 21 is a diagram of a long and narrow discontinuous-loop antenna according to embodiments.

### DETAILED DESCRIPTION

The subject is now described in more detail.

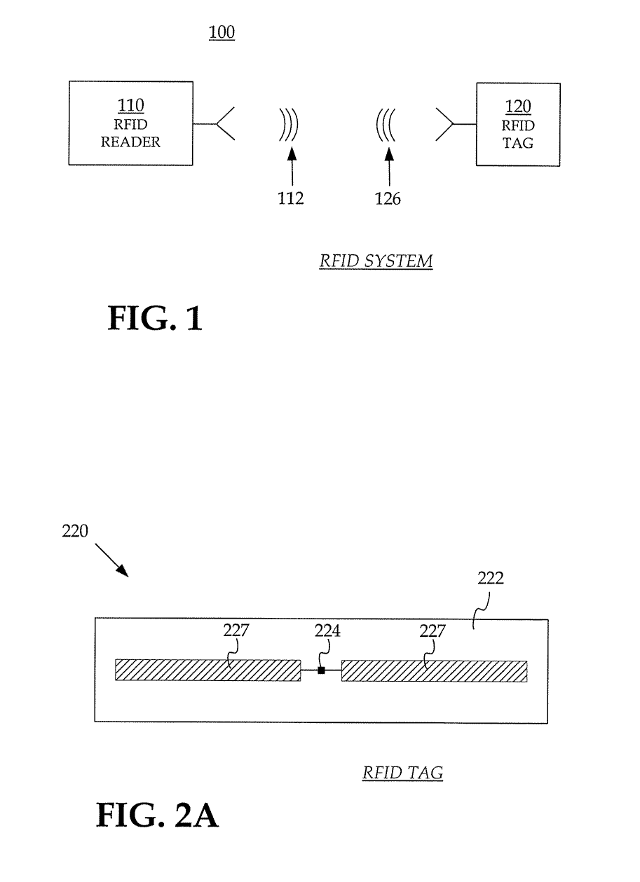

FIG. 1 is a diagram of components of a typical RFID system 100, incorporating aspects of the invention. An RFID reader 110 transmits an interrogating Radio Frequency (RF) wave 112. RFID tag 120 in the vicinity of RFID reader 110 may sense interrogating RF wave 112, and generate wave 126 in response. RFID reader 110 senses and interprets wave 126.

Reader 110 and tag 120 exchange data via wave 112 and wave 126. In a session of such an exchange, each encodes, modulates, and transmits data to the other, and each receives, demodulates, and decodes data from the other. The data is modulated onto, and decoded from, RF waveforms.

Encoding the data in waveforms can be performed in a number of different ways. For example, protocols are devised to communicate in terms of symbols, also called RFID symbols. A symbol for communicating can be a delimiter, a calibration symbol, and so on. Further symbols can be implemented for ultimately exchanging binary data, such as “0” and “1”, if that is desired. In turn, when the waveforms are processed internally by reader 110 and tag 120, they can be equivalently considered and treated as numbers having corresponding values, and so on.

Tag 120 can be a passive tag or an active tag, i.e. having its own power source. Where tag 120 is a passive tag, it is powered from wave 112.

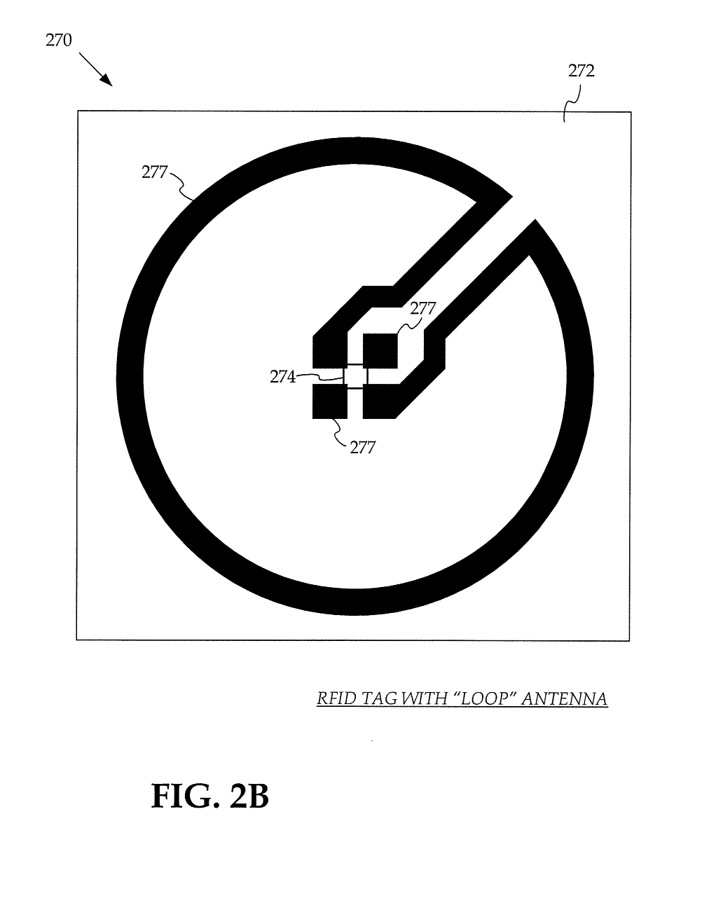

FIG. 2A is a diagram of an RFID tag 220, which can be the same as tag 120 of FIG. 1. Tag 220 is implemented as a passive tag, meaning it does not have its own power source. Much of what is described in this document, however, applies also to active tags.

Tag 220 is formed on a substantially planar inlay 222, which can be made in many ways known in the art. Tag 220 also includes two antenna segments 227, which are usually flat and attached to inlay 222. Antenna segments 227 are shown here forming a dipole, but many other embodiments using any number of antenna segments are possible, as will be seen later.

Tag 220 also includes an electrical circuit, which is preferably implemented in an integrated circuit (IC) 224. IC 224 is also arranged on inlay 222, and electrically coupled to antenna segments 227. Only one method of coupling is shown, while many are possible.

In operation, a signal is received by antenna segments 227, and communicated to IC 224. IC 224 both harvests power, and responds if appropriate, based on the incoming signal and its internal state. In order to respond by replying, IC 224 modulates the reflectance of antenna segments 227, which generates the backscatter from a wave transmitted by the reader. Coupling together and uncoupling antenna segments 227 can modulate the reflectance, as can a variety of other means.

In the embodiment of FIG. 2A, antenna segments 227 are separate from IC 224. In other embodiments, antenna segments may alternately be formed on IC 224, and so on.

An example of an RFID tag is now described, which is better suitable for being made in relatively smaller dimensions. A good rule of thumb is that the largest antenna dimension is less than λ/8, where λ is the wavelength of the frequency. For UHF RFID, at a frequency of 900 MHz, that wavelength λ is 33 cm (about 1 ft).

FIG. 2B is a diagram of an RFID tag 270, which can be the same as tag 120 of FIG. 1. Tag 270 is implemented as a passive tag, meaning it does not have its own power source. Much of what is described in this document, however, applies also to active tags.

Tag 270 is formed on a substantially planar inlay 272, which can be similar to inlay 222. Tag 270 also includes antenna segments 277, which are usually flat and attached to inlay 272. These antenna segments are advantageous for reading magnetic fields, and were first disclosed in copending U.S. Serial application Ser. No. 29/254,156, filed Feb. 17, 2006, Attorney Docket No. IMPJ-0189 (033327-000146).

Antenna segments 227 shown here are advantageous for small tags. Indeed, their largest dimension is the diameter of the large loop, which can be less than 4 cm. As such, they are well suited for tagging individual items, and especially small items, such as pharmaceuticals, etc.

Tag 270 also includes an electrical circuit, which is preferably implemented in an integrated circuit (IC) 274, similar to IC 224. Operation is similar as described above.

The components of the RFID system of FIG. 1 may communicate with each other in any number of modes. One such mode is called full duplex. Another such mode is called half-duplex, and is described below.

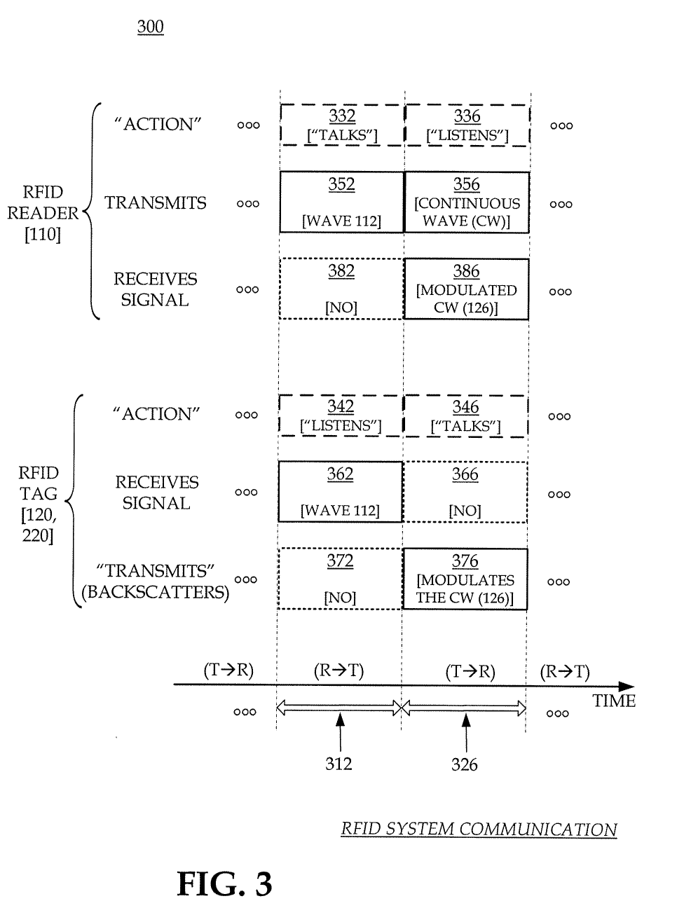

FIG. 3 is a conceptual diagram 300 for explaining the half-duplex mode of communication between the components of the RFID system of FIG. 1, especially when tag 120 is implemented as passive tag 220 of FIG. 2A, or tag 270 of FIG. 2B. The explanation is made with reference to a TIME axis, and also to a human metaphor of “talking” and “listening”. The actual technical implementations for “talking” and “listening” are now described.

RFID reader 110 and RFID tag 120 talk and listen to each other by taking turns. As seen on axis TIME, when reader 110 talks to tag 120 the communication session is designated as “R→T”, and when tag 120 talks to reader 110 the communication session is designated as “T→R”. Along the TIME axis, a sample R→T communication session occurs during a time interval 312, and a following sample T→R communication session occurs during a time interval 326. Of course interval 312 is typically of a different duration than interval 326—here the durations are shown approximately equal only for purposes of illustration.

According to blocks 332 and 336, RFID reader 110 talks during interval 312, and listens daring interval 326. According to blocks 342 and 346, RFID tag 120 listens while reader 110 talks (during interval 312), and talks while reader 110 listens (during interval 326).

In terms of actual technical behavior, during interval 312, reader 110 talks to tag 120 as follows. According to block 352, reader 110 transmits wave 112, which was first described in FIG. 1. At the same time, according to block 362, tag 120 receives wave 112 and processes it. Meanwhile, according to block 372, tag 120 does not backscatter with its antenna, and according to block 382, reader 110 has no wave to receive from tag 120.

During interval 326, tag 120 talks to reader 110 as follows. According to block 356, reader 110 transmits a Continuous Wave (CW), which can be thought of as a carrier signal that ideally encodes no information. As discussed before, this carrier signal serves both to be harvested by tag 120 for its own internal power needs, and also as a wave that tag 120 can backscatter. Indeed, during interval 326, according to block 366, tag 120 does not receive a signal for processing. Instead, according to block 376, tag 120 modulates the CW emitted according to block 356, so as to generate backscatter wave 126. Concurrently, according to block 386, reader 110 receives backscatter wave 126 and processes it.

In the above, an RFID reader/interrogator may communicate with one or more RFID tags in any number of ways. Some such ways are called protocols. A protocol is a specification that calls for specific manners of signaling between the reader and the tags.

One such protocol is called the Specification for RFID Air Interface—EPC™ Radio-Frequency Identity Protocols Class-1 Generation-2 UHF RFID Protocol for Communications at 860 MHz-960 MHz, which is also colloquially known as “the Gen2 Spec”. The Gen2 Spec has been ratified by EPCglobal, which is an organization that maintains a website at: <http://www.epcglobaline.org/> at the time this document is initially filed with the USPTO.

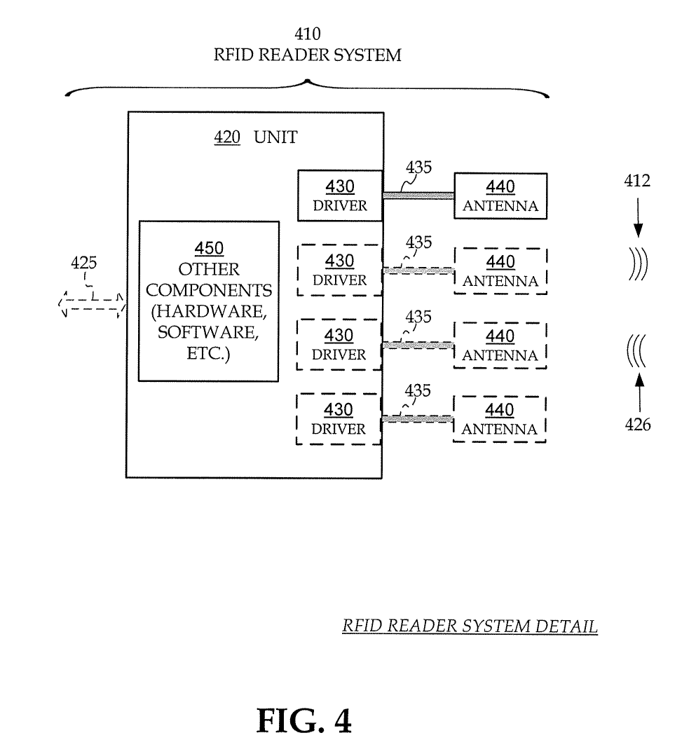

FIG. 4 is a block diagram showing a detail of an RFID reader system 410, which can be the same as reader 110 shown in FIG. 1. A unit 420 is also known as a box 420, and has at least one antenna driver 430. In typical embodiments it has four drivers 430. For each driver 430 there is an output, which is typically a coaxial cable plug. Accordingly cables 435 can be attached to the outputs of the provided respective drivers 430, and then the cables 435 can be attached to respective antennas 440.

A driver 430 can send a driving signal, to cause its respective antenna 440 to transmit an RF wave 412, which is analogous to RF wave 112 of FIG. 1. In addition, RF wave 426 can be backscattered from the RFID tags, analogous to RF wave 126 of FIG. 1. Backscattered RF wave 426 become a signal sensed by driver 430.

Unit 420 also has other components 450, such as hardware and software, which control drivers 430. Accordingly, components 450 cause RF wave 412 to be sent, and interpret the sensed backscattered RF wave 426. Optionally and preferably there is a communication link 425 to other equipment, such as computers and the like, for remote operation of system 410.

FIG. 5 is a diagram of a prior art dipole RFID reader antenna 540. Antenna 540 is made in a dipole configuration, where two conductors 547 are provided on an optional base 548. Base 548 can be a circuit board or other material known in the art, while conductors 547 can be metal traces formed on base 548, etc. Conductors 547 are excited by an excitation signal, which is typically received by conductors 535 from an RFID driver. Conductors 535 can be implemented as a coaxial cable as is known in the art.

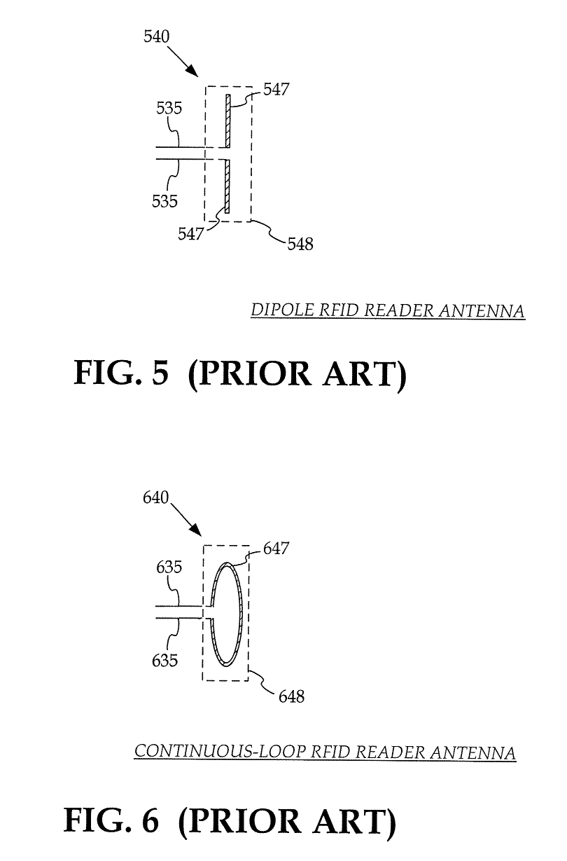

FIG. 6 is a diagram of a prior art solid loop RFID reader antenna 640. Antenna 640 is made in the so-called loop configuration, where a conductor 647 is provided as a mostly completed loop. It is understood that the loop is never fully closed—indeed if in were, no potential difference could be applied across it. In FIG. 6 the loop is intended as substantially circular, but is shown as an ellipse because it is a perspective drawing, considered turned from the horizontal.

Antenna 640 can be provided on an optional base 648, similarly to how antenna 540 can be provided on an optional base 548. Conductor 647 is excited by art excitation signal, which is typically received by conductors 635 from an RFID driver. Conductors 635 can be implemented as a coaxial cable as is known in the art.

An advantage of antenna 640 is that it can produce a substantially uniform magnetic field, but only if the perimeter length of the loop is less than one wavelength, and preferably less than a fraction of that. A useful antenna size for item level tagging is with conductor 647 having a loop perimeter of about 50 cm (about 20 in.)

These conditions can be met by HF RFID, whose frequency of about 13.56 MHz corresponds to a wavelength of about 22 m (more than 70 ft). If conductor 647 has a perimeter of 50 cm, it will work, because the phase drop along 50 cm is small compared to the long wavelength of 22 m. Indeed, there will be no self-canceling, because the length does not reach half a wavelength, after which the phase would invert.

A problem has been that these conditions could not be met by UHF RFID, whose wavelength is only 33 cm. The phase would invert within the loop, causing self-canceling, and thus no workable magnetic field would be generated.

The invention includes an antenna for an UHF RFID reader and methods for driving such antennas. In some embodiments, such antennas and driving them can produce a magnetic field that is usably large.

As will be seen from the below, antennas according to embodiments of the invention have special configurations. Such antennas can also be called discontinuous-loop antennas, or broken loop antennas. These special configurations include one, two or more loop sections. It will be understood that many of these loop sections are actually discontinuous, in that they are made by conductors, but there are gaps between them.

Each of these loop sections can resemble a loop, or not. If not, it could work with other loop sections to form an aggregate that resembles a loop, or not.

A set of embodiments is now described where the loop sections, each alone or in combination with each other, are shaped so that they actually resemble a loop. As will be seen, they confer the important advantage that their conductors generate magnetic subfields that become added. First an example of embodiments with a single loop section will be described, and then one with two, and thus their similarities will be understood.

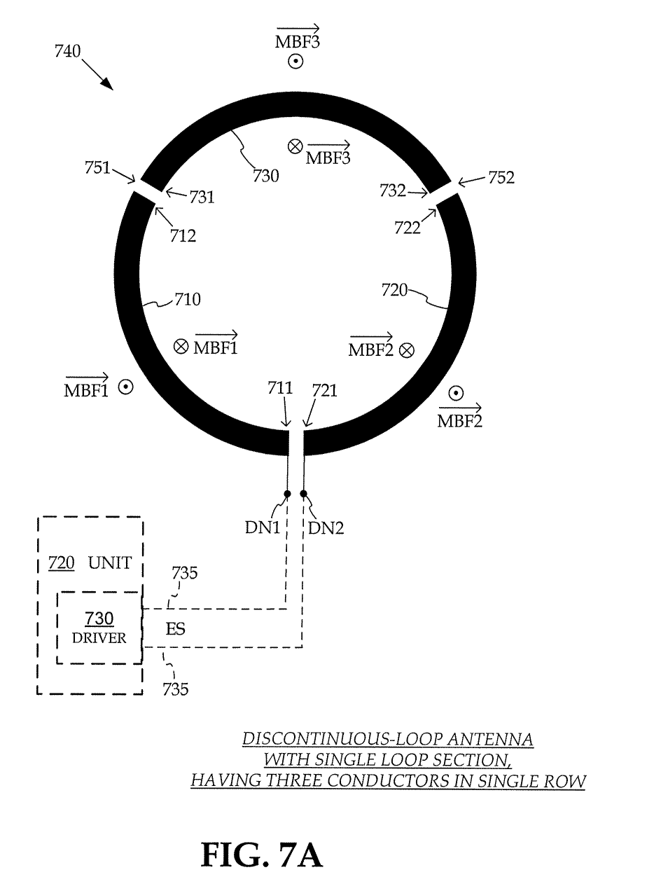

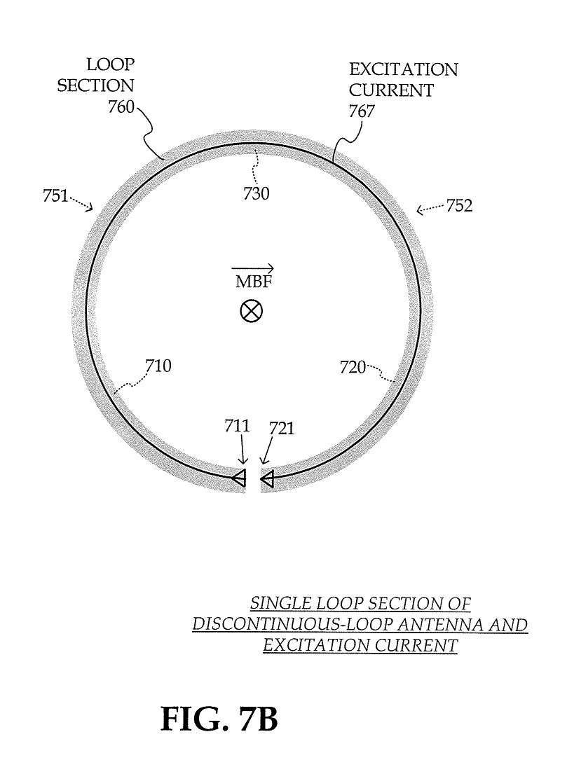

FIG. 7A is a block diagram of components 740 of a discontinuous-loop antenna according to an embodiment of the invention. FIG. 7A also shows how such an antenna may be driven, which can further apply to antenna embodiments other than that of FIG. 7A.

The antennas of the invention may be driven by driving components, which may or may not be similar to what was described in FIG. 4. For the example of FIG. 7A, these driving components can include a unit 720, a driver 730, and wires 735 that connect an output of driver 730 to two driving nodes DN1, DN2. First and second driving nodes DN1, DN2 can be the termination of wires 735. Wires 735 may advantageously be implemented by a coaxial cable.

These driving components are part of an RFID reader system that outputs an excitation signal ES as a potential difference between driving nodes DN1, DN2. Excitation signal ES is an AC signal, alternating at an excitation frequency larger than 200 MHz, and preferably where RFID domains can be established. Accordingly, in some embodiments, the excitation frequency is in a range centered on approximately 900 MHz, and in other embodiments the excitation frequency is in a range centered on approximately 2.4 GHz. When excitation signal ES is received by an antenna, such as that of FIG. 7A, it generates wireless fields for reception by one or more RFID tags. The wireless fields can be magnetic, electric, etc.

In some embodiments, an antenna according to the invention includes at least three conductors that do not contact each other. It will be appreciated that more than three conductors are used, and in fact some preferred embodiments have higher numbers of such conductors.

Each of these conductors includes a special portion called a loop portion, and possibly other extraneous portions. In some embodiments, such as described below, the conductors do not include other extraneous portions, if they do not need them. In those cases, the entire conductor is the loop portion.

Components 740 are now described. Components 740 include three elongate conductors 710, 720, 730, arranged substantially as shown. These conductors 710, 720, 730, along possibly with driving nodes DN1, DN2, could be provided as is known in the art, for example on a base (not shown), with means of attachment to wires 735, and so on. In some embodiments, they are advantageously provided so that they can replace an ordinary RFID reader antenna.

In more detail, conductor 710 has a first end 711 and a second end 712. Conductor 720 has a first end 721 and a second end 722. Conductor 730 has a first end 731 and a second end 732. As will be appreciated from the below, conductors 710, 720, 730, have no other extraneous portions, and are themselves the loop portions. In addition, the loop portions in this embodiment are also substantially elongate along the loop section, but that is not necessary.

Conductor 710 is coupled to receive excitation signal ES from first driving node DN1. In addition, conductor 720 is coupled to receive excitation signal ES from second driving node DN2. As such, excitation signal ES is applied between first driving node DN1 and second driving node DN2.

Signal ES is received at a point of conductor 710 that is called the first driving point. In this instance, the first driving point is first end 711, as is preferred. It is not required, however, that the first driving point be within the loop portion of the first conductor, or even at the end of it. In fact, it can be at a place different than the end, for example to accomplish phase matching, or as a termination, etc., as will be discerned by the person skilled in the art.

Signal ES can be received at the driving points in any number of ways. These can be implemented when designing how wires 735 will be attached to antenna components 740, or how coupling nodes in the antenna are connected to the loop portions. In some embodiments, as shown, the first driving point is arranged to come in contact with first driving node DN1. In other embodiments, the first driving point is coupled to receive excitation signal ES from first, driving node DN1 inductively across a gap.

Conductor 730 is not coupled to receive excitation signal ES directly from either one of driving nodes DN1, DN2. Instead, there is a small gap 751 between ends 712, 731, and a gap 752 between ends 722, 732. It will be appreciated that, if more non-contacting conductors are used than what is shown, there will be correspondingly more gaps between them. Even in that case, any one of the conductors that is not coupled to receive excitation signal ES directly from either one of driving nodes DN1, DN2 can be considered the third conductor, and so on.

Given the overall design, conductor 730 is coupled to receive excitation signal ES across gap 751 from conductor 710, and across gap 752 from conductor 720. Coupling takes place because excitation signal ES is alternating. This way conductor 730 will be driven from both its ends.

Furthermore, excitation signal ES, as received from conductor 710 into conductor 730, will be further coupled into conductor 720 via gap 752. In addition, excitation signal ES, as received from conductor 720 into conductor 730, will be further coupled into conductor 710 via gap 751. As such, driving nodes DN1, DN2, by applying excitation signal ES at driving points 711, 721, will be driving each one of conductors 710, 720, 730 from its ends. This way, excitation currents will become established along conductors 710, 730, and 720. Strictly speaking, these excitation currents will become established along the loop portions of conductors 710, 730, and 720, but in this case these loop portions are identified with the conductors themselves.

In proper parlance, there will be inductive excitation currents also across gaps 751, 752. This is possible because excitation signal ES is alternating at the high frequency of over 200 MHz. With proper design, all the excitation currents will he alternating substantially in unison.

An additional concept of the invention is now described, namely that of a discontinuous loop. This is also referred to as a loop section in this document. It should be remembered that it includes conductors with gaps between them, and that electrical current flows through the conductors, and also through the gaps, exactly because it is alternating at such a high frequency. Also, that its overall shape can resemble a loop, or not.

FIG. 7B is a diagram showing how components 740 of FIG. 7A can he considered as a discontinuous loop, or single loop section 760, shown in a thick gray line. It will be recognized that loop section 760 starts from first driving point 711, and continues with conductor 710, gap 751, conductor 730, gap 752, conductor 720, and ends at second driving point 721.

As also described above, individual excitation currents flow through each of conductor 710, gap 751, conductor 730, gap 752, and conductor 720, in response to excitation signal ES being applied at driving nodes DN1, DN2. In fact, it can be equivalently considered that there is a single excitation current 767 that becomes established along loop section 760. Excitation current 767 has substantially the same direction at every one of conductor 710, gap 751, conductor 730, gap 752, and conductor 720, but not necessarily the same magnitude, or the same phase. As will be seen later in this document, proper design in geometry, dimensioning, and the like, can cause the phase to have improved results.

As such, FIG. 7B provides a useful tool for visualizing the discontinuous loop. The tool will be used later in this document, because the invention is capable of many embodiments, and not all are described in this document individually.

Methods of the invention are now described. These methods can be practiced by antennas described in this document, and by readers driving such antennas.

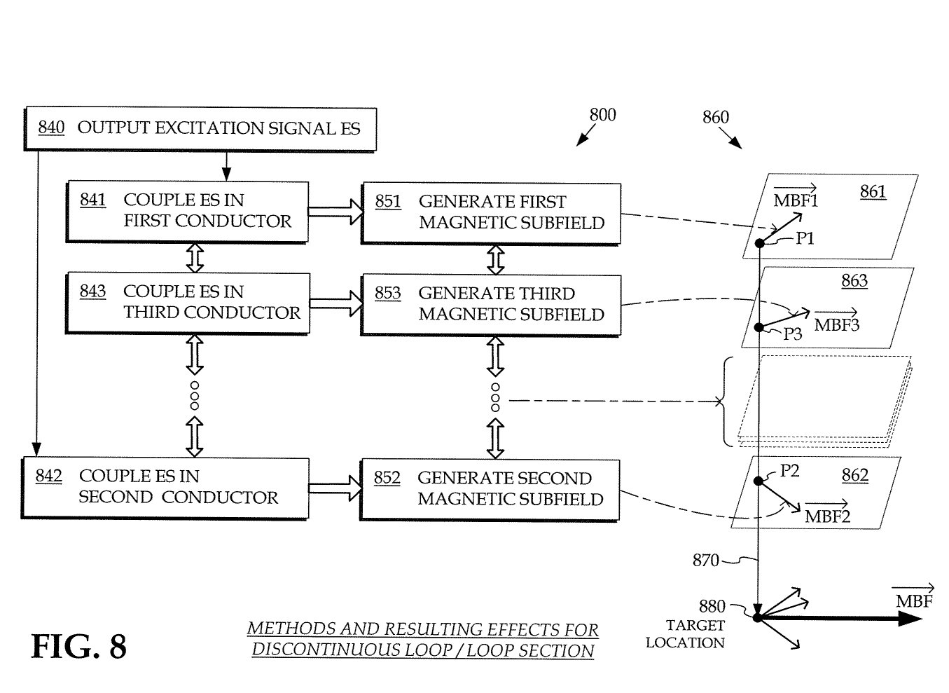

FIG. 8 is a composite diagram of a flowchart 860 for describing methods, and of an aggregate 860 for showing how individual magnetic field components can be added, according to embodiments of the invention.

These methods include coupling to an RFID reader system an antenna such as the antennas described in this document. For this particular description, the antenna of FIG. 7A and FIG. 7B will be used. However, such an antenna may already be coupled to the reader system.

According to an operation 840, an excitation signal is output from the RFID reader system. The excitation signal can be the same as excitation signal ES.

According to an operation 841, the output excitation signal is coupled to first driving point 711 of conductor 710.

According to an operation 842, the output excitation signal is coupled to second driving point 721 of conductor 720.

According to an operation 843, the excitation signal becomes coupled to third conductor 730, but inductively only, which means across gaps from conductor 710 and conductor 720. As also described above, since these conductors form a loop, conductor 710 will receive the excitation signal also via conductor 730, in addition to receiving it directly from first driving point 711. In addition, conductor 720 will receive the excitation signal also via conductor 730, in addition to receiving it directly from second driving point 721.

As a result, excitation currents will be established in conductors 710, 720, 730, and in fact all around the loop section. As will be seen, these excitation currents will generate wireless fields for communicating with the one or more RFID tags, as shown in FIG. 3.

According to a resulting operation 851, the established excitation current in conductor 710 will generate a first magnetic subfield /MBF1. This surrounds conductor 710, but only two points of it are shown. According to the right hand rule, magnetic subfield vector /MBF1 emerges from the page of FIG. 7A outside the loop section, and it goes into the page inside the loop section. In the general case, returning to FIG. 8, magnetic subfield vector /MBF1 can be considered at a chosen point P1. Point P1 is also drawn with reference to a convenient plane 861. The direction and magnitude of vector /MBF1 will depend on where point P1 is with respect to conductor 710.

According to a resulting operation 852, the established excitation current in conductor 720 will generate a first magnetic subfield /MBF2. This surrounds conductor 720, but only two points of it are shown. According to the right hand rule, magnetic subfield vector /MBF2 emerges from the page of FIG. 7A outside the loop section, and it goes into the page inside the loop section. In the general case, returning to FIG. 8, magnetic subfield vector /MBF2 can be considered at a chosen point P2. Point P2 is also drawn with reference to a convenient plane 862. The direction and magnitude of vector /MBF2 will depend on where point P2 is with respect to conductor 720.

According to a resulting operation 853, the established excitation current in conductor 730 will generate a first magnetic subfield /MBF3. This surrounds conductor 730, but only two points of it are shown. According to the right hand rule, magnetic subfield vector /MBF1 emerges from the page of FIG. 7A outside the loop section, and it goes into the page inside the loop section. In the general case, returning to FIG. 8, magnetic subfield vector /MBF1 can be considered at a chosen point P3. Point P3 is also drawn with reference to a convenient plane 863. The direction and magnitude of vector /MBF3 will depend on where point P3 is with respect to conductor 730.

Aggregate 860 shows how the magnetic subfields can be added, by vector addition. A target point 880 is selected with respect to the antenna, and thus is treated also as points P1, P2, P3 according to arrow 870. Magnetic subfield vectors /MBF1, /MBF2, and /MBF3 are added as components at target point 880, to yield a resultant magnetic field vector /MBF.

An important advantage is now described for the antenna configuration of FIG. 7A, as it forms the loop section of FIG. 7B. It will be observed that loop section 760 resembles a closed loop. More particularly, driving nodes DN1, DN2 are relatively close to each other. As such, within the loop section, magnetic subfield vectors /MBF1, /MBF2, and /MBF3 add to form a substantially uniform magnetic field. This is the same as choosing point 880 of FIG. 8 to be anywhere within the closed loop resembled by loop section 760.

It will be appreciated from FIG. 7B and FIG. 7A that components 740 form a single loop section, from points 711 to 721. Only two of conductors 710, 720, 730 are driven, as is preferred. More of these conductors can be driven, which increases the complexity of the device. An example is described below.

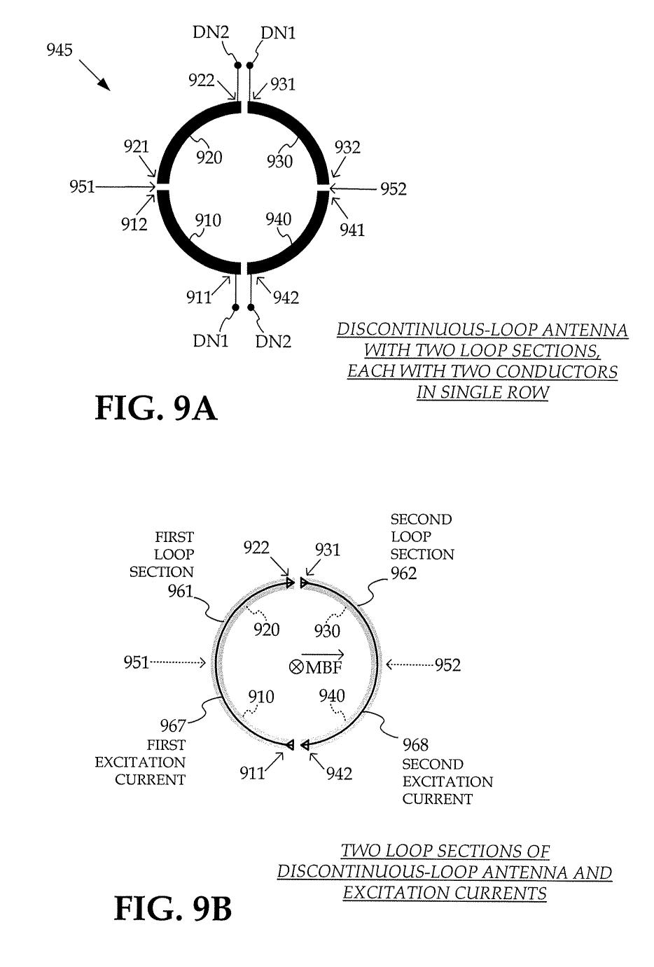

FIG. 9A is a block diagram of components 945 of a discontinuous-loop antenna according to an embodiment of the invention. Components 945 include conductors 910, 920, 930, 940, although more are possible, and in fact would be preferred for higher frequencies. Conductor 910 has ends 911, 912; conductor 920 has ends 921, 922; conductor 930 has ends 931, 932; and conductor 940 has ends 941, 942. Conductors 910, 920, are spatially arranged such that their closest point is gap 951. Conductors 930, 940, are spatially arranged such that their closest point is gap 952.

Components 945 are driven by the excitation signal delivered from two pairs of driving nodes DN1, DN2. These pairs are designated similarly, to indicate that it would be highly preferred that they deliver the exact same signal, in the exact same phase, which is preferred but not necessary. To accomplish that, one would have to ensure that transmission lines from the reader system (not shown) have the same delay, etc., which is one more thing to get right. This is not necessary in the embodiment of FIG. 7A, which is why embodiments with two pairs of driving nodes are not preferred.

FIG. 9B is a diagram showing how components 945 can be characterized. There are two loop sections 961, 962. First loop section 961 is defined from driving point 911 to driving point 922, and includes conductor 910, gap 951, and conductor 920. Second loop section 962 is defined from driving point 931 to driving point 942, and includes conductor 930, gap 952, and conductor 940.

Note that resulting loop sections 961, 962 carry their respective induced excitation currents 967, 968. Note further that excitation currents 967, 968 complete each other in an aggregate shape that again resembles a loop. They each result in magnetic subfields, which can be further added the same way as those from components 740, for a substantially similar resultant magnetic field vector /MBF.

It is instructive at this point to compare the discontinuous loops of FIG. 7B and FIG. 9B. Their resulting magnetic field vector /MBF can be substantially the same. In FIG. 9B there are two loop sections 961, 962, but that is only because there are artificially two pairs of driving nodes, not one. Still, these two loop sections 961, 962, taken together, generate a very similar result to single loop section 760. That is why, for the remainder of this document, discussion will be in terms of a single loop section, and a single pair of driving nodes, but that is only for economy. In fact, any of these embodiments can be converted to a one with two or more loop sections by merely adding driving nodes, and driving more of the conductors.

The discontinuous loops of FIG. 7B and FIG. 9B can be made different ways. Two conductors are driven directly by a driving node, at their driving points. Additional conductors can be added in between them, and are driven inductively, by those that are driven directly. The arrangement of the conductors, with a view to the path of the excitation current, is what defines the loop section.

It should be observed that, in all cases, the loop sections have a longer length than the individual conductors that constitute them. In fact, they can have a length longer than the wavelength of the excitation signal. This way an antenna with a large diameter can be made, even at the smaller wavelengths of the higher RFID frequencies. The antenna can be large enough to create a magnetic field that is usable over a large volume, for permitting accurate tag reading and fast throughput.

When the excitation current travels through the conductors, it creates an individual magnetic subfield from each. These fields can add to a resultant magnetic field can be substantially uniform, depending on the shape of the loop section. Plus the volume of the usable magnetic field can be optimized for the reading arrangement, by controlling the spatial arrangement of the conductors, as discussed later in this document.

Shapes of the loop sections are now described.

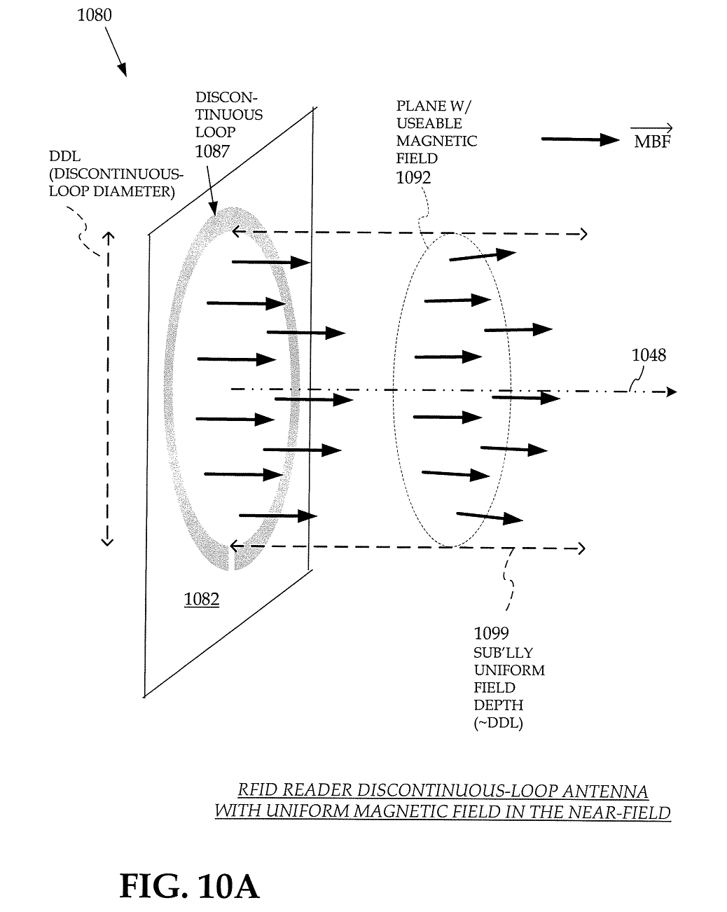

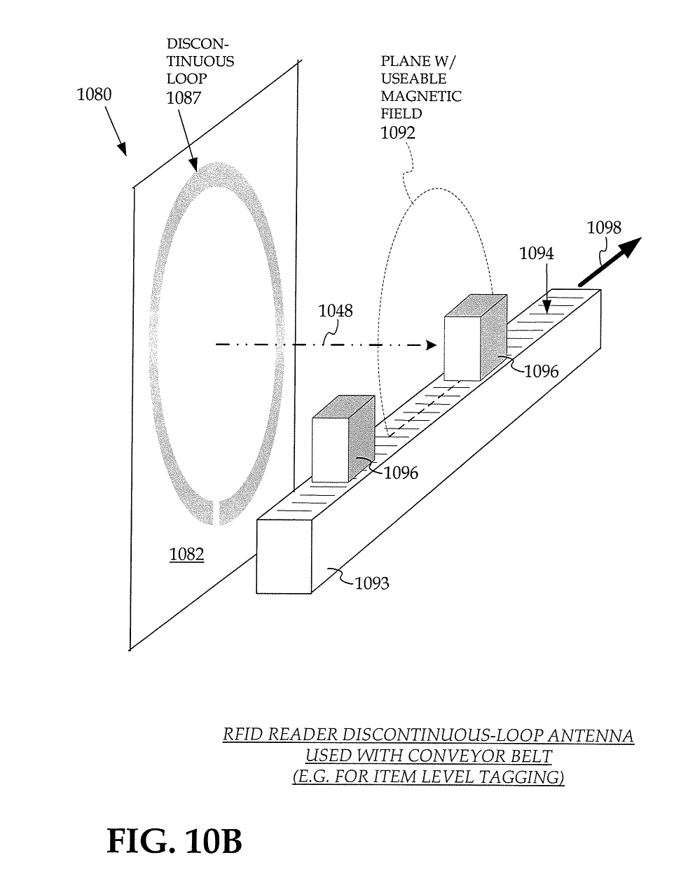

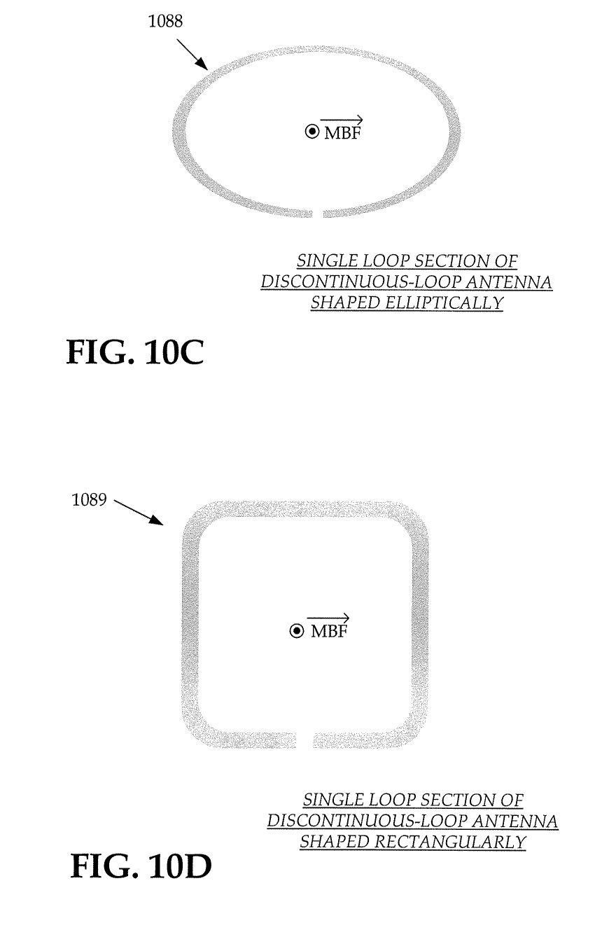

FIG. 10A is a perspective diagram of a discontinuous-loop antenna 1080 according to embodiments. Antenna 1080 is provided on a base 1082, which can be made as is known in the art.

Antenna 1080 has individual conductors (not shown individually) that are separated by gaps (not shown individually), and which together form a discontinuous loop 1087, which is also called a loop section 1087.

Discontinuous loop 1087 is shaped substantially like a circle in this embodiment. It appears as an ellipse only because this is a perspective drawing, seen somewhat from the side.

While discontinuous loop 1087 is substantially like a circle, it would not be like an exact full circle, because then it would be a completely closed loop that would not radiate. There is always at least one gap for each pair of driving nodes that are used.

When an excitation signal is applied as per the above to discontinuous-loop antenna 1080, a magnetic field is generated. The magnetic field is denoted by many arrows /MBF. The arrows have substantially the same size and direction, indicating that the magnetic field is uniform in that location. The field is the strongest at the plane of base 1082. A centerline 1048 is considered perpendicular to base 1082. The resulting magnetic field /MBF remains substantially uniform even at a distance 1099 which approximately equals DDL, the diameter of discontinuous loop 1087. A plane 1092 is shown, which is closer to base 1082 than DDL. This renders a large volume of usable magnetic field as is now described:

FIG. 10B is a perspective diagram showing how antenna 1080 of FIG. 10A can be used for item level tagging. Here antenna 1088 is of course used with the remainder of the RFID system, which is not shown in FIG. 10B for simplicity.

A conveyor 1093 has a surface 1094, on which items 1096 can be placed. Items 1096 would be tagged with RFID tags, and can be pharmaceuticals, etc. Antenna 1080 is placed such that its plane 1092 intersects surface 1094. It should be remembered that plane 1092 is indicative of a whole volume of usable magnetic field that can conduct the RFID communication of FIG. 3.

Surface 1094 can be moved in a direction shown by arrow 1098. As such, items 1096 on surface 1094 are passed by conveyor 1093, through the volume of usable magnetic field of antenna 1080, and can thus be read by the RFID system.

The discontinuous-loop of FIG. 10A has a substantially circular shape. That is only an example, and not a limitation. In fact, a discontinuous-loop can have many different of shapes. Two different embodiments will now be described.

FIG. 10C is a diagram showing a substantially elliptically shaped single loop section 1088 in a discontinuous-loop antenna according to embodiments.

FIG. 10D is a diagram showing a substantially rectangularly shaped single loop section 1089 in a discontinuous-loop antenna according to embodiments.

It has been found that such-shaped loop sections generate an usable magnetic field. In FIG. 10C and FIG. 10D, the field is also uniform, and the arrows are indicated as emerging from the plane of the paper.

Any number of combinations and shapes of non-contacting conductors can produce a discontinuous-loop antenna, having a loop section such as loop sections 1087, 1088, 1089. Examples were already described previously to this document. Some more examples are now described.

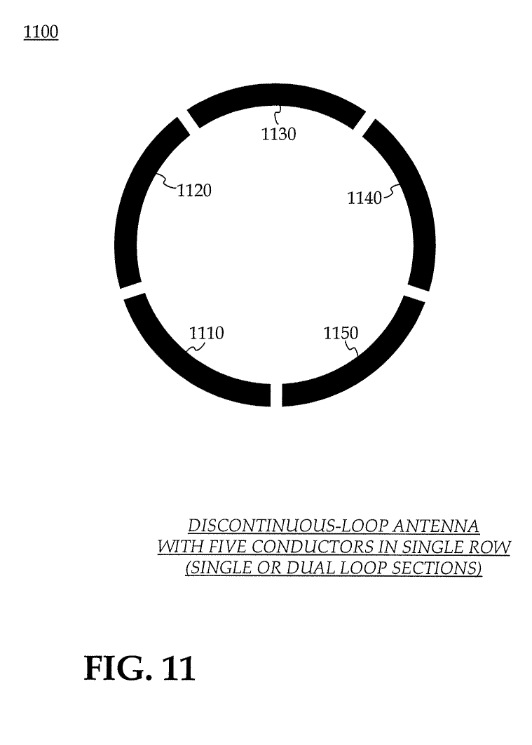

FIG. 11 is a diagram 1100 of conductors for a discontinuous-loop antenna made according to an embodiment. Conductors 1110, 1120, 1130, 1140, and 1150 are arranged in a single row, as will be appreciated later. They can form a single loop section, if two of them are driven by a single pair of driving nodes. Or they can be two cooperating loop sections, if four of them are driven by two pairs of driving nodes. The driving nodes can be added according to the loop sections.

It will be observed that, as cue transitions from a total of three conductors (as in FIG. 7A), to four (as in FIG. 9A), to five (as in FIG. 11), the individual conductors can become shorter in length. Indeed, while their loop portion is elongate to carry some of the excitation current along the loop portion, the loop portion can be divided in conductors that are more in number, and therefore whose elongate portion is shorter in length.

This is highly advantageous. It means that the loop portion of each conductor will carry less of a phase drop across it. This way the magnitude of the subfield will be less affected by the changing phase. More particularly, if the excitation frequency defines a wavelength λ, the loop portion can be made small enough to have a length smaller than λ/4, or even smaller than λ/8. An example is now described.

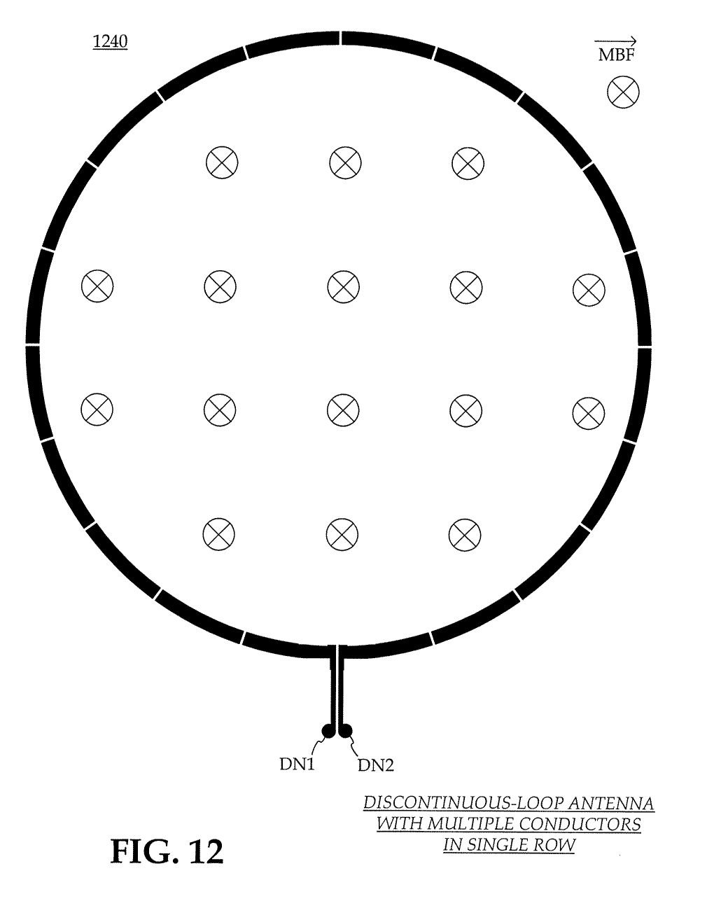

FIG. 12 is a diagram of conductors 1240 for a discontinuous-loop antenna made according to an embodiment. Conductors 1240 are arranged in a single row, and are driven by a single pair of driving nodes, thus forming a single discontinuous loop. The discontinuous loop is circular which, along with other conditions, can result in a uniform magnetic field /MBF within the circle. Conductors 1240 are elongate, and shorter than previously described conductors.

Advantageously, while the loop portions are made individually smaller, the whole loop section need not be so constrained. In fact, it can have a total length larger than λ, which is what permits the antennas of the invention to produce a magnetic field of useable size. As an example, in FIG. 10A, diameter DDL of the discontinuous loop 1087 can easily be 15 cm, as can depth 1099 of the uniform field. These are useable dimensions for RFID applications.

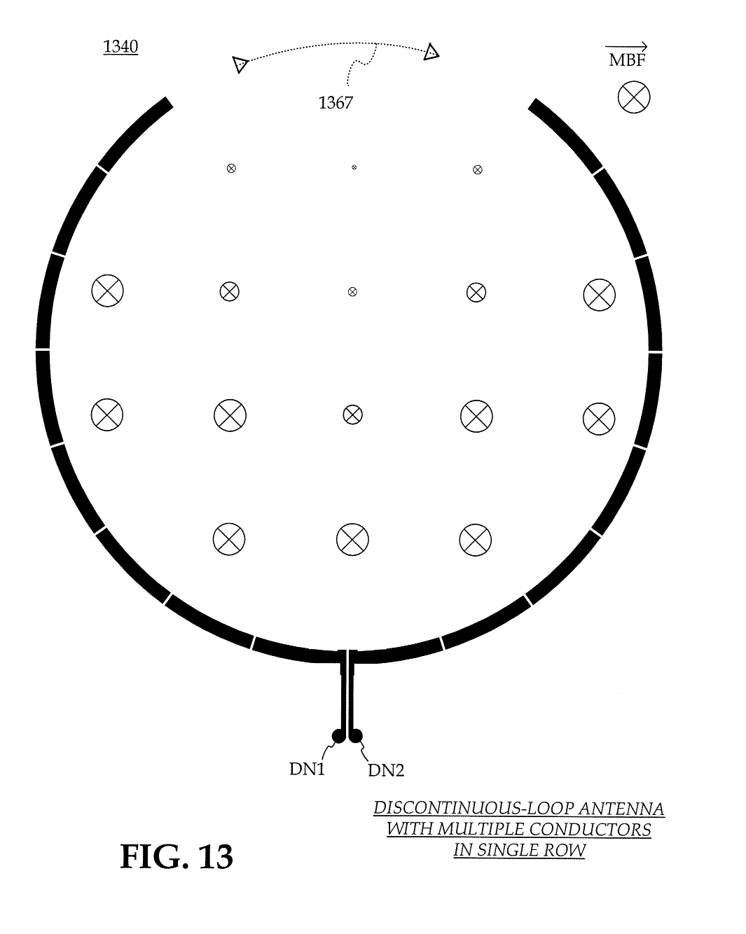

FIG. 13 is a diagram of conductors 1340 for a discontinuous-loop antenna made according to an embodiment. Conductors 1340 are derived by starting from conductors 1240 of the previous diagram, and removing some. This leaves an inefficiently large gap, which is why this is not preferred. Regardless, even in such an arrangement, a weak inductive current 1367 can still flow that bridges the gap. The field will not be uniform, but instead will be stronger closer to driving nodes DN1, DN2.

As mentioned above, the resultant magnetic field can be maximized in size, depending on the design. Proper design of the spatial arrangement of the conductors, their geometry, and the like can make it so that the phase difference of each field propagating within the loop portion of a conductor can be substantially matched to that of coupling to another segment.

In the above described embodiments, design has been facilitated by having the loop portions of the conductors be substantially elongate, and have substantially similar lengths. In fact, the entire conductors are substantially identical to each other.

More particularly, transmission of the excitation current via one of the loop portions of the conductors results in a lagging phase shift, or phase lag. In addition, transmission of the excitation current via the gaps results in a leading phase shift, or phase lead. It is preferred that the conductors are designed such that the phase lead cancels the phase lag. In so designing, the following should be considered.

Transmission via the loop portion of the conductor is something akin to transmission via a transmission line, or an inductor. The conductor can be a printed conductor, or a circuit board trace, or a wire. The amount of the phase lag is believed to go approximately in proportion to the length of the loop portion, at least as to first order.

Transmission via the gap is something akin to transmission via a capacitor, or coupling between coupled transmission lines, where there is distributed capacitance of the type that is through dielectric sandwiched between conductors. There would be also fringing capacitance between nearby circuit board traces (adjacent traces on same side of insulating substrate). The amount of the phase lead is believed to go in approximately proportion to gap width, divided by the overlap length, assuming no “point gaps”, and that there is some distribution of overlap.

A number of geometries are thus possible for the segments. One such geometry is where the loop portions of the conductor are substantially elongate, and terminates in two ends that are shaped with square-like corners. This is a convenient characterization of the shapes in the above described drawings, even though the corners are not exactly like those of a square, because the conductors can be actually bent.

Another such geometry is where one or more of the conductors are substantially elongate, and terminate in two ends that have slanted shapes. An example is now described.

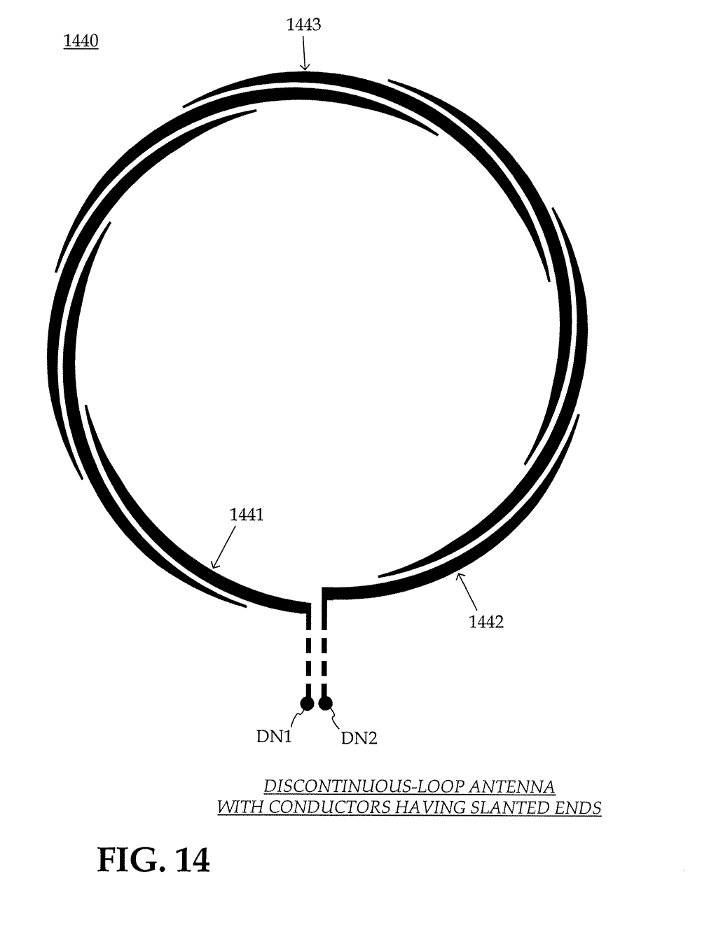

FIG. 14 is a diagram of a group 1441 of conductors for a discontinuous-loop antenna made according to an embodiment. Of those, a first conductor 1441, a second conductor 1442, and a third conductor 1443 are individually designated. These conductors have slanted ends, to maximize the overlap described above. The overlap results in more efficient coupling.

Another way to perform efficient coupling is to have the conductors be in two or more rows. This way, the easy-to-design square-like corners can be retained. Examples are now described.

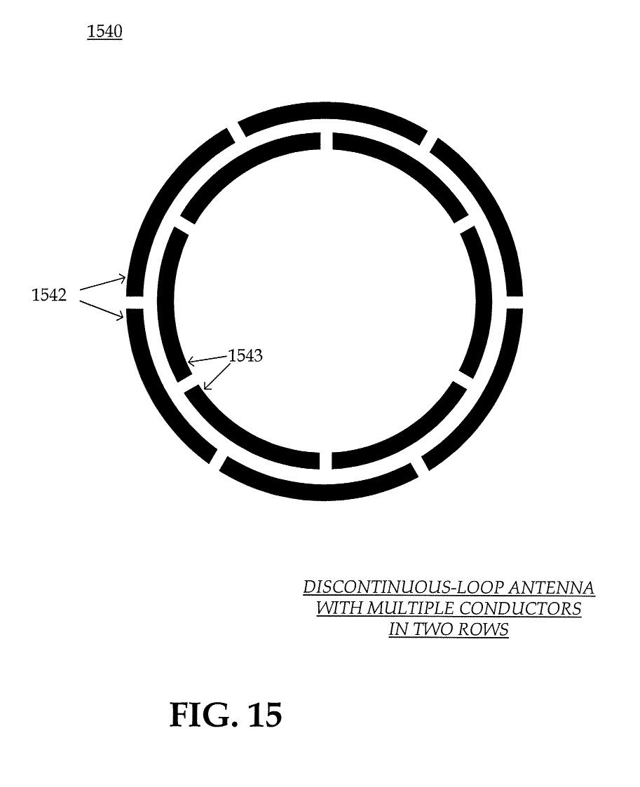

FIG. 15 is a diagram of a group 1540 of conductors for a discontinuous-loop antenna made according to an embodiment. The conductors in group 1540 are arranged is two rows, one of which substantially surrounds the other. For example, conductors 1542 are in an outer row, and conductors 1543 are in an inner row.

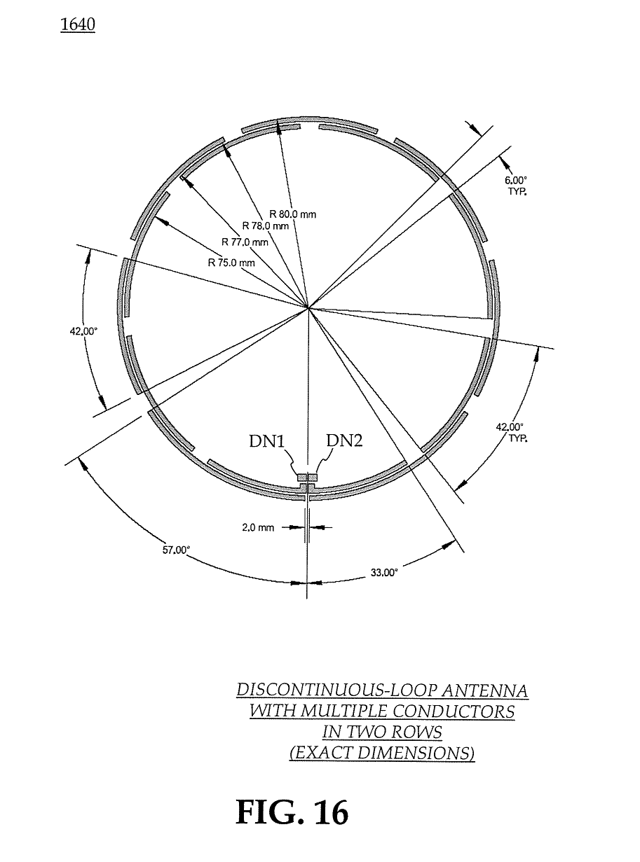

FIG. 16 is a diagram of a group 1640 of conductors for a discontinuous-loop antenna made according to an embodiment. FIG. 16 further shows exact dimensions that are known to work well. The inner radius is 75.0 mm, and so the inner radius is 15 cm (close to 6 in.).

In the far field, an electromagnetic pattern is formed by this antenna that is equivalent to, and sometimes indistinguishable from, that of a dipole. This way RFID tags can be read as known.

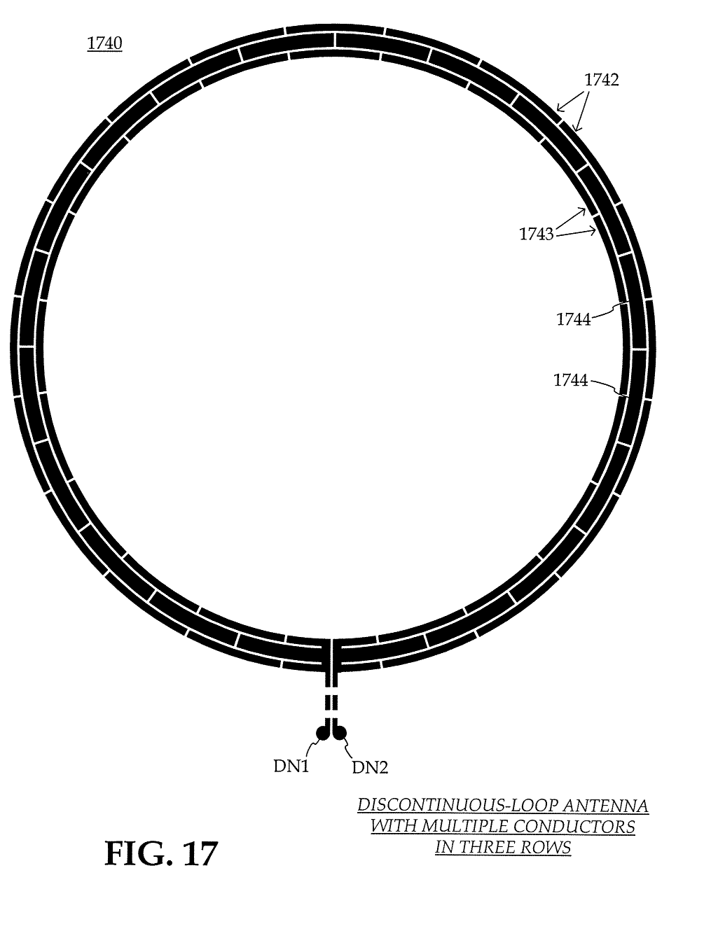

FIG. 17 is a diagram of a group 1740 of conductors for a discontinuous-loop antenna made according to an embodiment. The conductors in group 1740 are arranged in three rows. Conductors 1742 are in an outer row, conductors 1743 are in an inner row, and conductors 1744 are in a middle row.

A noteworthy item about distributing the conductors in two or more rows is that these rows, taken together, still correspond to a single loop section, or discontinuous loop per this description. They are simply a more efficient way to implement one.

Another noteworthy item about distributing the conductors in two or more rows is that the total conductor length can be larger than the length of the loop section. It can be 20% larger, or more than twice as large, and so on.

As will have become clear by now, it is not necessary that the non-contacting conductors belong in exact rows. For example, they can be staggered, not forming rows along exact lines. In addition, it is not necessary that the non-contacting conductors be identical to each other, or have the same electrical characteristics. For example, one of them can be replaced by a load, and so on. Variations like this can help guide the excitation signal in higher detail.

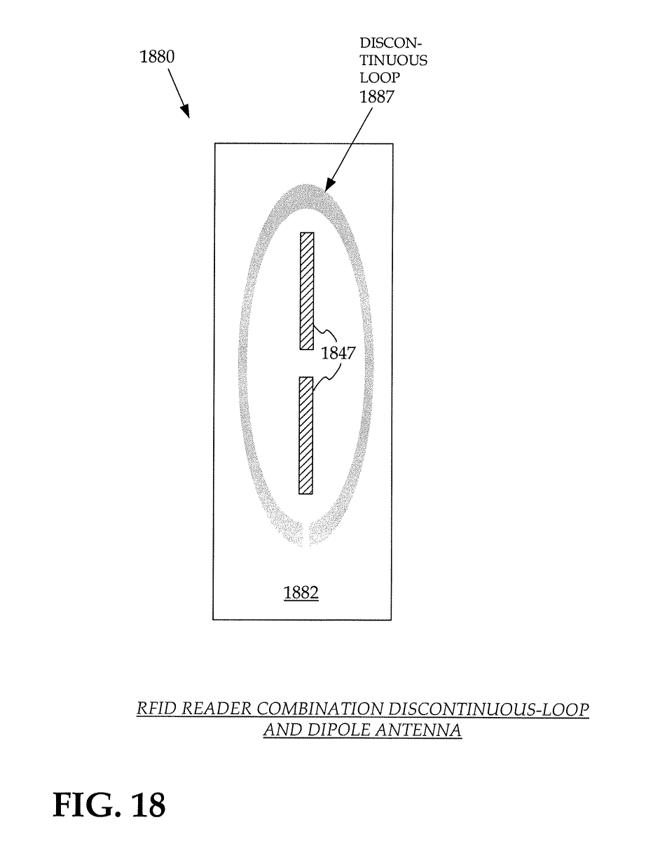

FIG. 18 is a perspective diagram showing of a combination antenna 1880 according to embodiments. It is provided on a base 1882, which can be made as is known in the art.

Antenna 1880 is made from a discontinuous-loop antenna and a dipole antenna. The discontinuous-loop antenna is made from individual conductors (not shown individually), which that are separated by gaps (not shown individually), and which together form a discontinuous loop section 1887. The dipole antenna is made from two conductors 1847 on base 1882, which can be similar to conductors 547.

Antenna 1380 can radiate from either the discontinuous-loop antenna, or the dipole antenna, or both. If from only one of them, then it can receive a single excitation signal, which can be routed to one or to the other by a switch. Or each can be controlled independently, as is shown for separate antennas in FIG. 4.

As mentioned above, where the loop section resembles a loop, there is the advantage that the subfields become added within it, such as shown in FIG. 10A and FIG. 10B. There can be other designs, however, where a different portion of the magnetic subfield is used. Some such examples are described below.

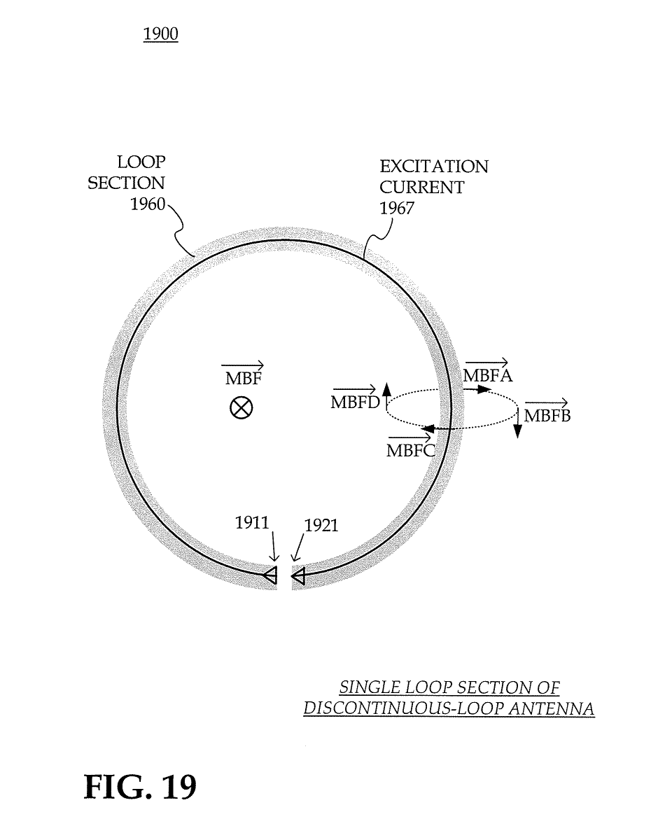

FIG. 19 is a diagram of loop section of a discontinuous-loop antenna according to embodiments, for discussing versatility of designs. An antenna 1900 includes a loop section 1960, starting from point 1911 and ending in point 1921. Loop section 1960 is made as per the above. When an excitation signal is applied, an excitation current 1967 is established. Since loop section 1960 resembles a closed loop, a resultant magnetic field /MBF is created, which points into the page.

Attention is drawn now to individual magnetic subfield /MBFD, which is a component of resultant magnetic field /MBF that is generated from a portion of loop section 1960, but where the portion is not shown individually. It will be appreciated that the portion can be a conductor or a loop portion of a conductor as described above. Individual magnetic subfield /MBFD also technically points into the page within loop section 1960, as also seen in FIG. 7A, but here it is drawn with a little perspective, so as to better visualize its behavior at other locations. As such, vector /MBFD is perpendicular to the plane of the antenna.

According to the right hand rule, the individual magnetic subfield can also be represented by vectors /MBFA, /MBFB and /MBFC at other locations. Vector /MBFB points exactly out of the page, as also seen in FIG. 7A, but here is again drawn with a little perspective. Vectors /MBFA and /MBFC are parallel to the page and to the plane of loop section 1960, with /MBFA below the page and /MBFC above the page, as per the right band rule.

The systems described above in detail communicate with the tags by exploiting the individual magnetic subfield primarily at the location shown by vector /MBFD, occurring within loop section 1960. In other words, the antenna is oriented relative to the tagged items such that the items are passed through vector /MBFD by the conveyor, such as seen in FIG. 10B. For that system, the conveyor could equivalently also go through the antenna, along its centerline.

Other systems are also possible, which primarily exploit the individual magnetic subfields at locations that they are characterized instead by vectors /MBFA, /MBFB and /MBFC. This is accomplished by proper orientation of the antenna and the conveyor. In all such cases, the vectors that are not exploited will have a tendency to be formed anyway, but can be ignored. Suitable design can ensure they do not have an adverse impact.

In addition, more than one loop sections can be used. These can be excited by a single or multiple pairs of driving nodes. A single pair is preferred.

Some examples are now described.

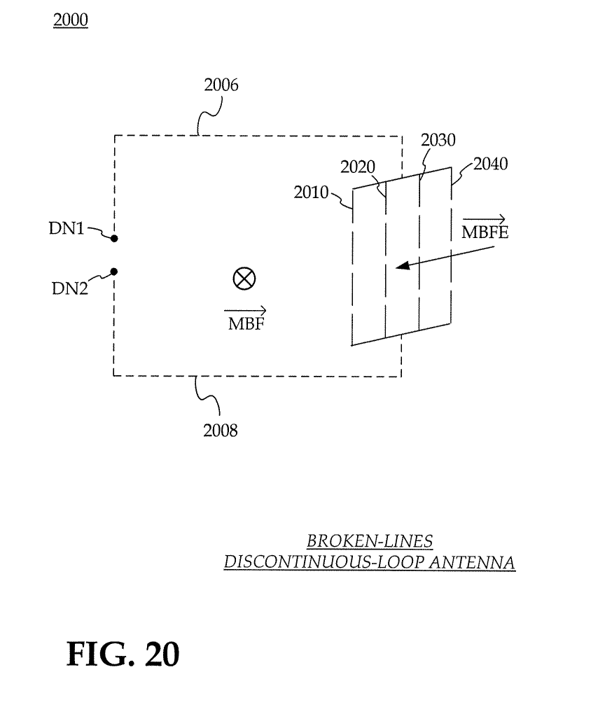

FIG. 20 is a diagram of a discontinuous-loop antenna 2000 according to other embodiments. A number of discontinuous loop sections 2010, 2020, 2030, 2040 are substantially parallel to each other. A colloquial name for them is “broken-lines”. In some embodiments, these loop sections 2010, 2020, 2030, 2040 are close enough to each other so that the excitation current crosses over among them. In that case, they can be fairly considered a single discontinuous loop section. In other embodiments, they are far enough apart to where it does not, and each generates its own magnetic subfields, which are then added.

Antenna 2000 receives an excitation signal from driving nodes DN1, DN2. Two feeders 2006, 2008 deliver the excitation signal from driving nodes DN1, DN2 to loop sections 2010, 2020, 2030, 2040. Feeders 2006, 2008 can either be themselves discontinuous as shown, or continuous. If continuous, then they can be part of the conductors delivering the signal, and the driving nodes can be considered to be at the ends of discontinuous loop sections 2010, 2020, 2030, 2040.

In either case, magnetic subfield /MBFE is generated for communication with the RFID tags. Given the arrangement, vector /MBFE, which can be oriented as any one of vectors /MBFA, /MBFB, /MBFC, and /MBFD.

If feeders 2006, 2008 are discontinuous as shown, then another loop section can alternately be construed, from driving node DN1 to driving node DN2. This would give rise to a magnetic field MBF, which is not used in this instance.

An advantage of antenna 2000 is that it can be made with long discontinuous loop sections 2010, 2020, 2030, and 2040. This way vector /MBFE will be available over a long length, which can be aligned with the direction of travel of a conveyor.

In the above example, if discontinuous loop sections 2010, 2020, 2030, 2040 are far enough apart, no conductors are shared by them. In other instances, they some conductors can be shared. An example is now described.

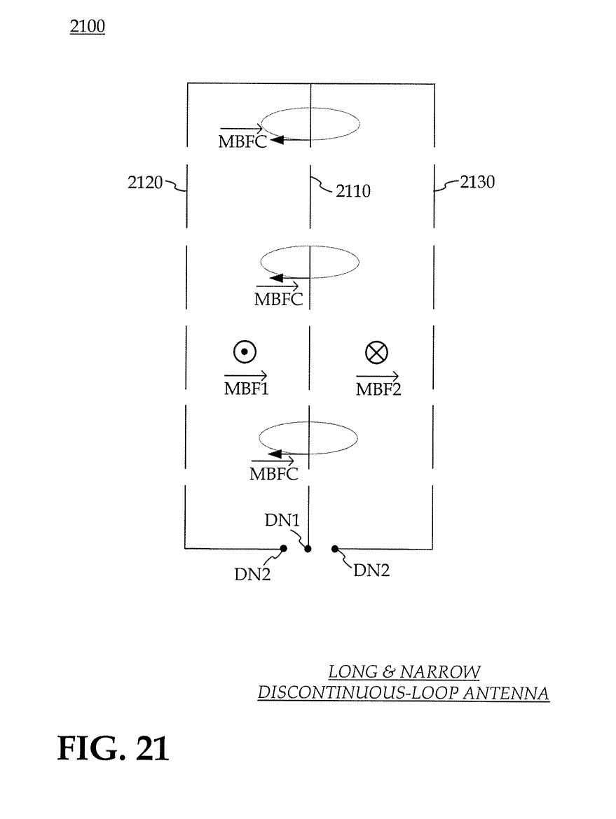

FIG. 21 is a diagram of a discontinuous-loop antenna 2100 according to embodiments, which can be made relatively long and narrow. Antenna 2100 has conductors in a single place, which are arranged in three discontinuous loop sections 2110, 2120, and 2130. They are driven by driving nodes DN1, DN2. A full value of the excitation current goes from DN1 through discontinuous loop section 2110, then splits into two, and each half value returns from discontinuous loop sections 2120, 2130. For this embodiment, it is preferred that one of the conductors of loop section 2110 includes a resistive load at the point where it meets loop sections 2120, 2130.

These can equivalently be considered as two loop sections, namely one formed by loop sections 2110 and 2120, and one formed by loop sections 2110 and 2130. Both resemble closed loops; the first gives rise to magnetic field /MBF1 at the plane of the conductors, while the second gives rise to magnetic field /MBF2 at the plane of the conductors. Neither /MBF1 nor /MBF2 are used in this embodiment. Instead, at a plane higher than that of the conductors, vector /MBFC can be primarily exploited, which is centered above the conductors forming discontinuous loop section 2110.

An advantage of antenna 2100 is that it can be made with long discontinuous loop sections 2010, 2120, 2130. This length can be aligned with the conveyor's direction of movement. In addition, it can be made narrow, by having discontinuous loop sections 2120, 2130 be not far from each other. The useful field /MBFC will be provided for most of the length, and more than half the width, since the return current is half the size.

In this description, numerous details have been set forth in order to provide a thorough understanding. In other instances, well-known features have not been described in detail in order to not obscure unnecessarily the description.

A person skilled in the art will be able to practice the present invention in view of this description, which is to be taken as a whole. The specific embodiments as disclosed and illustrated herein are not to be considered in a limiting sense. Indeed, it should be readily apparent to those skilled in the art that what is described herein may be modified in numerous ways. Such ways can include equivalents to what is described herein.

The following claims define certain combinations and subcombinations of elements, features, steps, and/or functions, which are regarded as novel and non-obvious. Additional claims for other combinations and subcombinations may be presented in this or a related document.

The claimed invention is:

1. An antenna for use with a Radio Frequency Identification (RFID) reader system that outputs as a potential difference between a first driving node and a second driving node an excitation signal alternating at an excitation frequency larger than 200 MHz, the antenna for generating wireless fields responsive to receiving the excitation signal for communicating with an RFID tag, the antenna comprising:
a first conductor coupled to receive at a first driving point the excitation signal from the first driving node;
a second conductor coupled to receive at a second driving point the excitation signal from the second driving node; and
a third conductor, and
in which
the first, the second, and the third conductors do not contact each other, and include respective loop portions that are spatially arranged along a loop section that starts from the first driving point and ends at the second driving point, the loop portions being separated by gaps along the loop section,
the third conductor is coupled to receive the excitation signal across the gaps from the first conductor and from the second conductor, and
responsive to thus receiving the excitation signal, an excitation current becomes established along the loop portions of the first, the second, and the third conductors, the excitation current thereby generating the wireless fields.

2. The antenna of claim 1, in which
the excitation frequency is in a range centered around approximately 900 MHz.

3. The antenna of claim 1, in which
the excitation frequency is in a range centered around approximately 2.4 GHz.

4. The antenna of claim 1, in which
the first driving point is arranged to come in contact with the first driving node to receive the excitation signal.

5. The antenna of claim 1, in which
the first driving point is coupled to receive the excitation signal from the first driving node inductively across a gap.

6. The antenna of claim 1, in which
the loop section is substantially circularly shaped.

7. The antenna of claim 1, in which
the loop section is substantially elliptically shaped.

8. The antenna of claim 1, in which
the loop section is substantially rectangularly shaped.

9. The antenna of claim 1, further comprising:
a fourth conductor not contacting any of the first, the second, and the third conductors, the fourth conductor having an elongate loop portion along the loop section, the loop portion of the fourth conductor separated from the loop portions of the second conductor and the third conductor by gaps along the loop section, the loop portion of the fourth conductor being thus coupled to receive the excitation signal inductively only from the third conductor and from the second conductor such that the excitation current becomes established along the loop portion of also the fourth conductor.

10. The antenna of claim 1, in which
the excitation frequency defines a wavelength λ, and
the loop portion of the third conductor is elongate and has a length smaller than λ/4.

11. The antenna of claim 1, in which
the excitation frequency defines a wavelength λ, and
the loop portion of the third conductor is elongate and has a length smaller than λ/8.

12. The antenna of claim 1, in which
the excitation frequency defines a wavelength λ, and
the loop section has a length larger than λ.

13. The antenna of claim 1, further shaped such that
the loop portion of the third conductor is substantially elongate and has a shape that introduces a phase lag in the propagation of the excitation current being received from the first conductor,
a gap between the third conductor and the second conductor has a shape that introduces a phase lead in the propagation of the excitation current from the third conductor to the second conductor, and
the lead substantially cancels the lag.

14. The antenna of claim 1, in which
the loop portions of the first, the second, and the third conductors are substantially elongate and have substantially similar lengths.

15. The antenna of claim 1, in which
the loop portion of the third conductor is substantially elongate and terminates in two ends that are shaped with square-like corners.

16. The antenna of claim 1, in which
the loop portion of the third conductor is substantially elongate and terminates in two ends that have slanted shapes.

17. The antenna of claim 1, in which
the loop section is disposed within a single plane.

18. The antenna of claim 17, in which
the excitation current established along the loop portion of the third conductor generates a magnetic subfield around the third conductor, and
the wireless field for communication with the RFID tag is primarily the magnetic subfield at a location where it has a direction perpendicular to the plane.

19. The antenna of claim 17, in which
the excitation current carried in the third conductor generates a magnetic subfield around the third conductor, and
the wireless field for communication with the RFID tag is primarily the magnetic subfield at a location where it has a direction parallel to the plane.

20. The antenna of claim 1, in which
the loop section is not disposed within a single plane.

21. The antenna of claim 1, further comprising:
a plurality of conductors arranged along a second loop section.

22. The antenna of claim 21, in which
the second loop section is excited by the first and the second driving node.

23. The antenna of claim 21, in which
no conductors are shared by the two loop sections.

24. The antenna of claim 21, in which
some conductors are shared by the two loop sections.

25. The antenna of claim 1, further comprising:
a plurality of additional conductors not contacting any of each other, the first, the second, and the third conductors, the additional conductors having respective elongate loop portions along the loop section that are separated by gaps along the loop section, and
in which the additional conductors are coupled so receive the excitation signal inductively only across some of the gaps from the first conductor and from the second conductor such that the excitation current becomes established along the loop portions of also the additional conductors.

26. The antenna of claim 25, in which
the loop section is disposed within a single plane.

27. The antenna of claim 25, in which
the loop section is not disposed within a single plane.

28. The antenna of claim 25, in which
the loop portions of all of the additional conductors are spatially arranged along the loop section in a single row.

29. The antenna of claim 25, in which
the additional conductors are at least 7 in number.

30. The antenna of claim 25, in which
at least three of the additional conductors have shapes that are substantially similar with each other.

31. The antenna of claim 30, in which
the three of the additional conductors are adjacent to each other, and separated by two gaps with shapes that are substantially similar with each other.

32. The antenna of claim 25, in which
the loop portions of at least three of the additional conductors are substantially elongate, and spatially arranged along the loop section in a first row, and
the loop portions of at least another three of the additional conductors are spatially arranged along the loop section in a second row that substantially surrounds the first row.

33. The antenna of claim 32, in which
at least some of the loop portions of the additional conductors are elongate and have a total length more than 120% of a length of the loop section.

34. The antenna of claim 32, in which
at least three more of the loop portions of the additional conductors are spatially arranged along the loop section in a third row that substantially surrounds the first row and the second row.

35. The antenna of claim 34, in which
at least some of the loop portions of the additional conductors are elongate and have a total length more than twice a length of the loop section.

36. A method for a Radio Frequency Identification (RFID) reader system to communicate with Radio Frequency Identification (RFID) tags, the system including a coupled antenna having at least a first, a second, and a third non-contacting conductors, the first, the second, and the third conductors including respective loop portions that are spatially arranged along a loop section that starts from a first driving point of the first conductor and ends at a second driving point of the second conductor, the loop portions being separated by gaps along the loop section, the method comprising:
outputting from the system an excitation signal alternating at an excitation frequency larger than 200 MHz such that the excitation signal is coupled to the first driving point and to the second driving point, the excitation signal thereby being coupled inductively only also to the third conductor, and an excitation current thereby becoming established along the loop portions of the first, the second, and the third conductors, the excitation current thereby generating wireless fields for communicating with the RFID tags.

37. The method of claim 36, in which
the excitation frequency is in a range centered around approximately 900 MHz.

38. The method of claim 36, in which
the excitation frequency is in a range centered around approximately 2.4 GHz.

39. The method of claim 36, in which
the excitation signal is coupled to the first driving point by bringing a first driving node of the system in contact with the first driving point.

40. The method of claim 36, in which
the excitation signal is coupled to the first driving point inductively across a gap.

41. The method of claim 36, in which
the loop section is substantially circularly shaped.

42. The method of claim 36, in which
the loop section is substantially elliptically shaped.

43. The method of claim 36, in which
the loop section is substantially rectangularly shaped.

44. The method of claim 36, in which
the antenna has a fourth conductor not contacting any of the first, the second, and the third conductors, the fourth conductor having an elongate loop portion along the loop section, the loop portion of the fourth conductor separated from the loop portions of the second conductor and the third conductor by gaps along the loop section, and
the excitation current becomes established along the loop portions of also the fourth conductor.

45. The method of claim 36, in which
the excitation frequency defines a wavelength λ, and
the loop portion of the third conductor has a length smaller than λ/4.

46. The method of claim 36, in which
the excitation frequency defines a wavelength λ, and
the loop portion of the third conductor has a length smaller than λ/8.

47. The method of claim 36, in which
the excitation frequency defines a wavelength λ, and
the loop section has a length larger than λ.

48. The method of claim 36, in which
the antenna is further shaped such that
the loop portion of the third conductor is elongate and has a shape that introduces a phase lag in the propagation of the excitation current being received from the first conductor,
a gap between the third conductor and the second conductor has a shape that introduces a phase lead in the propagation of the excitation current from the third conductor to the second conductor, and
the phase lead substantially cancels the phase lag.

49. The method of claim 36, in which
the loop portions of the first, the second, and the third conductors are substantially elongate and have substantially similar lengths.

50. The method of claim 36, in which
the loop portion of the third conductor is substantially elongate and terminates in two ends that are shaped with square-like corners.

51. The method of claim 36, in which
the loop section is disposed within a single plane.

52. The method of claim 51, in which
the excitation current established along the loop portion of the third conductor generates a magnetic subfield around the third conductor, and
the wireless field for communication with the RFID tags is primarily the magnetic subfield at a location where it has a direction perpendicular to the plane.

53. The method of claim 51, in which
the excitation current established along the loop portion of the third conductor generates a magnetic subfield around the third conductor, and
the wireless field for communication with the RFID tags is primarily the magnetic subfield at a location where it has a direction parallel to the plane.

54. The method of claim 36, in which
the loop section is not disposed within a single plane.

55. An antenna for use with a Radio Frequency Identification (RFID) reader system that outputs as a potential difference between a first driving node and a second driving node an excitation signal alternating at an excitation frequency larger than 200 MHz, the antenna for generating wireless fields responsive to receiving the excitation signal for communicating with an RFID tag, the antenna comprising:
a first conductor coupled to receive at a first driving point the excitation signal from the first driving node;
a second conductor coupled to receive at a second driving point the excitation signal from the second driving node;
a third conductor coupled to receive at a third driving point the excitation signal from the first driving node; and
a fourth conductor coupled to receive at a fourth driving point the excitation signal from the second driving node;
in which
the first, the second, the third, and the fourth conductors do not contact each other and include respective loop portions,
the loop portions of the first conductor and of the second conductor are spatially arranged along a first loop section that starts from the first driving point and ends at the second driving point, and are separated by a first gap along the first loop section,
the loop portions of the third conductor and of the fourth conductor are spatially arranged along a second loop section that starts from the third driving point and ends at the fourth driving point, and are separated by a second gap along the second loop section, and
responsive to thus receiving the excitation signal, a first excitation current becomes established that has a non-zero magnitude along the entire first loop section, and a second excitation current becomes established that has a non-zero magnitude along the entire second loop section, the first and the second excitation currents thereby generating the wireless fields.

56. The antenna of claim 55, in which
the excitation frequency is in a range centered around approximately 900 MHz.

57. The antenna of claim 55, in which
the excitation frequency is in a range centered around approximately 2.4 GHz.

58. The antenna of claim 55, in which
the first driving point is arranged to come in contact with the first driving node to receive the excitation signal.

59. The antenna of claim 55, in which
the first driving point is coupled to receive the excitation signal from the first driving node inductively across a gap.

60. The antenna of claim 55, in which
the first loop section and the second loop section, taken together, form a shape that is substantially like a circle.

61. The antenna of claim 55, in which
the first loop section and the second loop section, taken together, form a shape that is substantially like an ellipse.

62. The antenna of claim 55, in which
the first loop section and the second loop section, taken together, form a shape that is substantially like a rectangle.

63. The antenna of claim 55, further comprising:
a fifth conductor not contacting any of the tint, the second, the third, and the fourth conductors, the fifth conductor having an elongate loop portion along the first loop section, the loop portion of the fifth conductor separated from the loop portions of the first conductor and the second conductor by gaps along the first loop section, the loop portion of the fifth conductor being thus coupled to receive the excitation signal inductively only from the first conductor and from the second conductor such that the first excitation current becomes established along the loop portion of also the fifth conductor.

64. The antenna of claim 55, in which
the excitation frequency defines a wavelength λ, and
the loop portion of the third conductor in elongate and has a length smaller than λ/4.

65. The antenna of claim 55, in which
the excitation frequency defines a wavelength λ, and
the loop portion of the third conductor is elongate and has a length smaller than λ/8.

66. The antenna of claim 55, in which
the excitation frequency defines a wavelength λ, and
the first loop section has a length larger than λ.

67. The antenna of claim 55, in which
the loop portions of the first, the second, and the third conductors are substantially elongate and have substantially similar lengths.

68. The antenna of claim 55, in which
the loop portion of the third conductor is substantially elongate and terminates in two ends that are shaped with square-like corners.

69. The antenna of claim 55, in which
the loop portion of the third conductor is substantially elongate and terminates in two ends that have slanted shapes.

70. The antenna of claim 55, in which
the first and the second loop sections are disposed within a single plane.

71. The antenna of claim 70, in which
the excitation current established along the loop portion of the third conductor generates a magnetic subfield around the third conductor, and
the wireless field for communication with the RFID tag is primarily the magnetic subfield at a location where it has a direction perpendicular to the plane.

72. The antenna of claim 70, in which
the excitation current established along the loop portion of the third conductor generates a magnetic subfield around the third conductor, and
the wireless field for communication with the RFID tag is primarily the magnetic subfield at a location where it has a direction parallel to the plane.

73. The antenna of claim 55, in which
the loop portions of the first, the second, the third and the fourth conductors are elongate and have substantially similar lengths.

74. The antenna of claim 55, in which
the loop portion of the third conductor is elongate and terminates in two ends that are shaped with square-like corners.

75. The antenna of claim 55, further comprising;
a plurality of conductors arranged along a third loop section.

76. The antenna of claim 75, in which
the third loop section is excited by the first and the second driving node.

77. A method for a Radio Frequency Identification (RFID) reader system to communicate with Radio Frequency Identification (RFID) tags, the system including a coupled antenna having at least a first, a second, a third, and a fourth non-contacting conductors, the loop portions of the first conductor and of the second conductor being spatially arranged along a first loop section that starts from a first driving point of the first conductor and ends at a second driving point of the second conductor, and being separated by a first gap along the first loop section, the loop portions of the third conductor and of the fourth conductor being spatially arranged along a second loop section that starts from a third driving point of the third conductor and ends at a fourth driving point of the fourth conductor, and being separated by a second gap along the second loop section, the method comprising:
outputting from the system an excitation signal alternating at an excitation frequency larger than 200 MHz such that the excitation signal is coupled to the first, the second, the third, and the fourth driving points, a first excitation current thereby becoming established that has a non-zero magnitude along the entire first loop section, and a second excitation current becoming established that has a non-zero magnitude along the entire second loop section, the first and the second excitation currents thereby generating wireless fields for communicating with the RFID tags.

78. The method of claim 77, in which
the excitation frequency is in a range centered around approximately 900 MHz.

79. The method of claim 77, in which
the excitation frequency is in a range centered around approximately 2.4 GHz.

80. The method of claim 77, in which
the excitation signal is output as a potential difference between a first driving node and a second driving node,
the first driving node is coupled to the first driving point and to the third driving point, and
the second driving node is coupled to the third driving point and to the fourth driving point.

81. The method of claim 80, in which
the first driving node is coupled to the first driving point by being in contact with it.

82. The method of claim 80, in which
the first driving node is coupled to the first driving point inductively across a gap.

83. The method of claim 77, in which
the first loop section and the second loop section, taken together, form a shape that is substantially like a circle.

84. The method of claim 77, in which
the first loop section and the second loop section, taken together, form a shape that is substantially like an ellipse.

85. The method of claim 77, in which
the first loop section and the second loop section, taken together, form a shape that is substantially like a rectangular.

86. The method of claim 77, in which
the excitation frequency defines a wavelength λ, and
the loop portion of the third conductor is elongate and has a length smaller than λ/4.

87. The method of claim 77, in which
the excitation frequency defines a wavelength λ, and
the loop portion of the third conductor is elongate and has a length smaller than λ/8.

88. The method of claim 77, in which
the excitation frequency defines a wavelength λ, and
the first loop section has a length larger than λ.

89. The method of claim 77, in which
the loop portions of the first, the second, and the third conductors are substantially elongate and have substantially similar lengths.

90. The method of claim 77, in which
the loop portion of the third conductor is substantially elongate and terminates in two ends that are shaped with square-like corners.

91. The method of claim 77, in which
the loop portion of the third conductor is substantially elongate and terminates in two ends that have slanted shapes.
